(19) United States
(12) Patent Application Publication
(10) Pub. No.: US 2025/0197684 A1
(43) Pub. Date: Jun. 19, 2025

(54) SEAM TAPE, PATCH MATERIAL, ACCESSORY MATERIAL, OR COMPONENT MATERIAL WITH HIGH TEMPERATURE SUBSTRATE

(71) Applicant: AIR CRUISERS COMPANY, LLC, Wall Township, NJ (US)

(72) Inventor: Kelly Svihla, Robbinsville, NJ (US)

(21) Appl. No.: 18/538,601

(22) Filed: Dec. 13, 2023

(51) Int. Cl. C09J 7/35; A62B 1/20; B64D 25/14; C09J 5/06; E04H 15/20

(52) U.S. Cl. CPC C09J 7/35; C09J 5/06; A62B 1/20; B64D 25/14; C09J 2423/048; C09J 2467/00; C09J 2479/08; E04H 15/20

(57) ABSTRACT

A seam tape may be provided to independently and indirectly couple panels to create an inflatable product. Each panel includes a first substrate, and the seam tape includes a second substrate having a melt temperature that greater than a melt temperature of the first substrate. A method of adhering a seam tape, patch material, accessory material, or component material to a panel includes positioning the seam tape, patch material, accessory material, or component material on the panel such that the seam tape, patch material, accessory material, or component material receives more heat than the panel when adhering the seam tape, patch material, accessory material, or component material to the panel.

### FIELD OF THE INVENTION

The field of the invention relates to seam tapes, patch materials, component materials, and accessory materials for inflatable safety products such as but not limited to inflatable evacuation slides, slide/rafts, ramps, slide/ramps, life rafts, life vests, helicopter floats, and inflatable shelters.

### BACKGROUND

Federal aviation safety regulations require aircraft to provide evacuation and other safety provisions for passengers. These include, but are not limited to, inflatable evacuation slides, slide/rafts, ramps, slide/ramps, life rafts, life vests, helicopter floats, inflatable shelters, emergency flotation devices, inflatable shelters (military and nonmilitary), ship decoys and inflatable military targets, any other flotation devices, rescue equipment, and/or other safety device requiring rapid inflation and/or secure gas-holding functions. These inflatable devices are generally built from an assembly of inflatable tubular structures that form airbeams that are sealed to one another. Inflatable slides and life rafts also commonly include non-gas-holding features, such as patches, floors, canopies, sliding surfaces, girts, handles, and other features.

Inflatable safety products may include both gas-holding structures and non-gas-holding structures. Typically, in order to form the tubular structures, many pieces of gas-holding fabric are joined together. Typically, in order to form non-gas-holding features, such as patches, floors, canopies, sliding surfaces, girts, and other features, multiple pieces of component fabric are joined together or may be joined with gas-holding fabric panels. Gas-holding fabric and non-gas-holding fabric may be referred to herein as panels. Seam tapes, patch materials, accessory materials, or component materials are commonly joined to such gas-holding fabric to form the tubular structures with gas-holding properties and/or to attach other components to the gas-holding fabric. Traditionally, the substrates of the seam tapes, patch materials, accessory materials, or component materials are materials that are the same as the substrates of the gas-holding fabric. As an example, nylon may be used as the substrate for both the gas-holding fabric as well as the seam tape, patch material, accessory material, or component material. However, such typical arrangements may be difficult to join using heat (e.g., via hot air welding) without damaging the substrate of the gas-holding or non-gas-holding fabric. Additionally, such typical arrangements may be difficult to join without damaging the gas barrier of gas-holding fabric.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present disclosure, a seam tape for independently and indirectly coupling gas-holding or non-gas-holding panels to create an inflatable product includes a substrate having a melt temperature that greater than a melt temperature of a substrate of the panels to which the seam tape is applied.

According to certain embodiments of the present disclosure, an inflatable safety product includes a gas-holding panel or non-gas-holding panel with a first substrate comprising a first melt temperature. The inflatable safety product further includes a seam tape, patch material, accessory material, or component material joined to the gas-holding panel or non-gas-holding panel. The seam tape, patch material, accessory material, or component material includes a second substrate having a second melt temperature, and the second melt temperature is greater than the first melt temperature.

According to certain embodiments of the present disclosure, a method of adhering a seam tape, patch material, accessory material, or component material to a gas-holding panel or non-gas-holding panel includes positioning the seam tape, patch material, accessory material, or component material on the gas-holding panel or non-gas-holding panel such that the seam tape, patch material, accessory material, or component material receives more heat than the gas-holding panel or non-gas-holding panel when adhering the seam tape, patch material, accessory material, or component material to the gas-holding panel. In various embodiments, a substrate of the gas-holding panel or non-gas-holding panel has a first melt temperature and the substrate of the seam tape, patch material, accessory material, or component material has a second melt temperature greater than the first melt temperature.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates an inflatable safety product with gas-holding panels and a seam tape, patch material, accessory material, or component material according to embodiments.

FIG. 2 illustrates a portion of one of the gas-holding panels of FIG. 1 according to embodiments.

FIG. 3 illustrates a portion of the seam tape, patch material, accessory material, or component material of FIG. 1 according to embodiments.

FIG. 4 illustrates a joining system for joining the seam tape, patch material, accessory material, or component material the gas-holding fabric panel according to embodiments.

FIG. 5 is a top view of the joining system of FIG. 4.

### DETAILED DESCRIPTION

Described herein are seam tapes, patch materials, accessory materials, or component materials for inflatable safety products, as well as inflatable safety products incorporating such seam tapes, patch materials, accessory materials, or component materials. Compared to traditional approaches, the substrates of the seam tapes, patch materials, accessory materials, or component materials (hereinafter “second substrates”) have a higher melting temperature point than the substrates of the gas-holding or non-gas-holding fabric panels (hereinafter “first substrates”).

In certain embodiments, the second substrates having the higher melting temperature compared to the first substrates may allow for joining of the seam tapes, patch materials, accessory materials, or component materials to the air holding fabric panels or non-gas-holding fabric panels using heat, such as but not limited to via hot air welding, while minimizing and/or preventing damage to the first substrate. In various embodiments, seam tapes, patch materials, accessory materials, or component materials with the second substrates described herein may allow for a majority of the total energy (e.g., heat) needed to join the seam tapes, patch materials, accessory materials, or component materials to be applied to the seam tapes, patch materials, accessory materials, or component materials rather than the gas-holding fabric or non-gas-holding panel, thereby reducing the risk of damaging the gas-holding fabric panel or non-gas-holding fabric panel during a heat-joining process such as thermobonding, welding, other suitable techniques, and/or combinations thereof.

In certain embodiments, by using the second substrate with the higher temperature in the seam tape, patch material, accessory material, or component material, that seam tape, patch material, accessory material, or component material may be heated to a temperature at or above the temperature needed to join or weld the seam tape, patch material, accessory material, or component material to the gas-holding fabric panel or non-gas-holding fabric panel, thereby reducing the risk of damaging the substrate and thereby reducing risk of compromising the integrity of the seam tape, patch material, accessory material, or component material. In various embodiments, the systems and methods described herein may allow for joining or welding of the seam tape, patch material, accessory material, or component material to the gas-holding fabric panel without damaging the gas barrier of the gas-holding fabric.

In various embodiments, the seam tape, patch material, accessory material, or component material described herein may meet and/or exceeds the requirements according to TSO-C69c from the Federal Aviation Administration (FAA), entitled EMERGENCY EVACUATION SLIDES, RAMPS, RAMP/SLIDES, AND SLIDE RAFTS and published Aug. 18, 1999 (“TSO-C69c”) (incorporated herein by reference), TSO-C13f from the FAA, entitled LIFE PRESERVERS and published Sep. 24, 1992 (“TSO-C13f”) (incorporated herein by reference), and/or TSO-C70b from the FAA, entitled LIFE RAFTS and published Aug. 4, 2014 (“TSO-C70b”) (incorporated herein by reference). Various other benefits and advantages may be realized with the systems and methods described herein, and the aforementioned benefits and advantages should not be considered limiting.

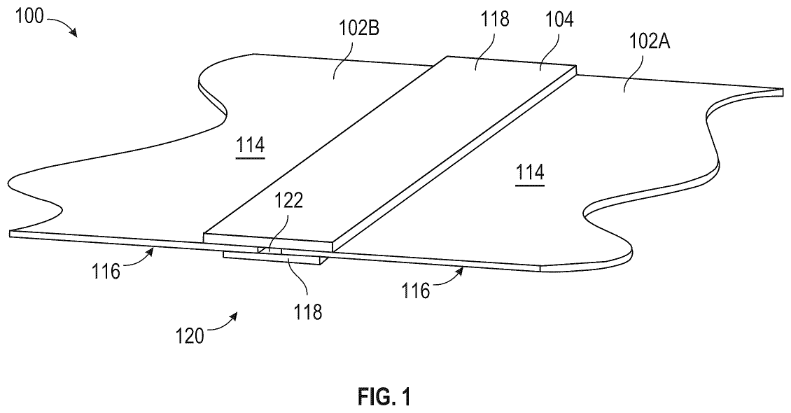

FIG. 1 illustrates an example of an inflatable safety product 100 according to embodiments. The inflatable safety product 100 generally includes one or more one or gas-holding panels or non-gas-holding panels 102 (collectively referred to hereinafter “primary panels 102”) and at least one seam tape, patch material, accessory material, or component material 104. The primary panels 102 generally include outer surfaces 114 and inner surfaces 116, and the seam tape, patch material, accessory material, or component material 104 may be adhered to at least one of the surfaces 114, 116.

In the embodiment illustrated in FIG. 1, the seam tape, patch material, accessory material, or component material 104 is provided as a seam tape 118. In this example, the seam tape 118 is provided to join a seam region 120 (e.g., a butt seam) formed by a first primary panel 102A and a second primary panel 102B. As illustrated in FIG. 1, a gap 122 may be formed between the primary panels 102A-B, and the seam tape 118 may cover the gap 122. Optionally, an air holding film 124 is provided in the seam region 120 and on a surface of the panels 114A-B opposite from the seam tape 118. While the seam tape 118 is illustrated on the outer surface 114, it need not be in other embodiments. Moreover, while a single seam tape 118 is illustrated, any number of seam tapes 118 and/or other seam tape, component material, or accessory material 104 may be provided on the outer surface 114 and/or the inner surface 116 of one or more panels 102 as desired. Moreover, while the seam tape, component material, or accessory material 104 is illustrated as the seam tape 118 for the inflatable safety product 100, as previously mentioned, in other embodiments, the seam tape, component material, or accessory material 104 may be provided as a patch material, component material and/or an accessory material, such as but not limited to a patch, girt, handle, structural attachment, or pouch.

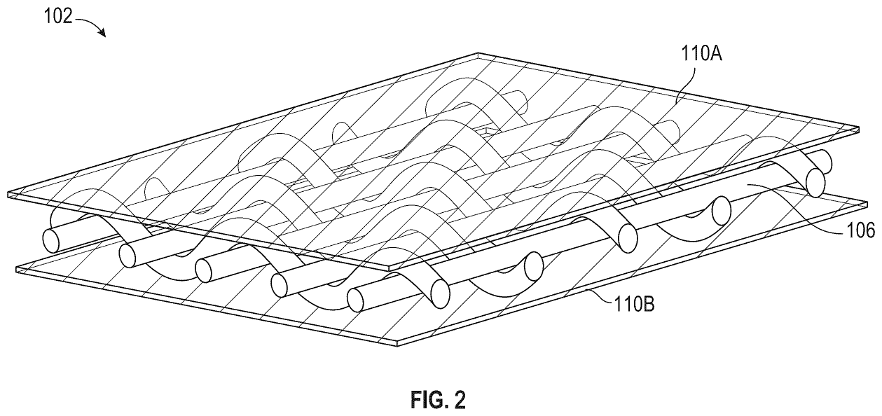

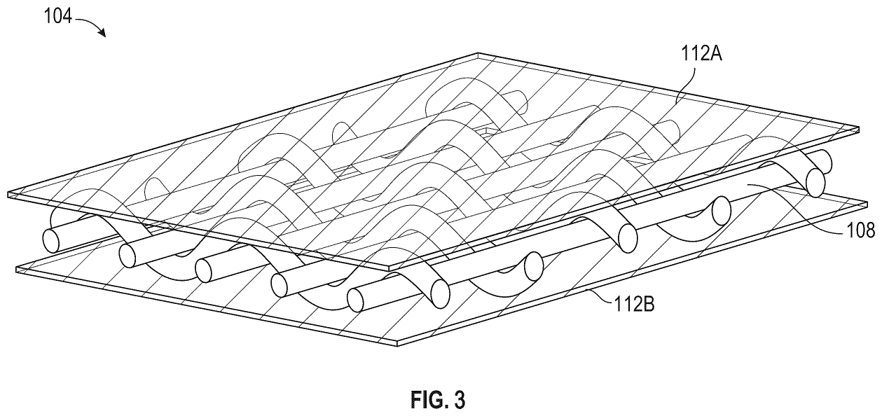

Referring to FIGS. 2 and 3, each primary panel 102 generally includes a first substrate 106, and the seam tape, patch material, accessory material, or component material 104 generally includes a second substrate 108. The first substrate 106 and the second substrate 108 may be constructed from various materials as desired, such as but not limited to various fabric or flexible composite materials. As non-limiting examples, the substrates 106, 108 may be constructed from materials such as but not limited to polyethylene, ultra-high molecular weight polyethylene, polypropylene, polyester, polyamide, aromatic polyamide, aramid, polyolefin, aromatic polyester, polyarylate, liquid crystal polymers, other suitable substrate material, and/or any combination thereof. As additional non-limiting examples, the substrates 106, 108 may be a material such as but not limited to those sold under the trade names Dyneema®, Spectra®, Innegra®, Vectran®, Technora®, Kevlar®, Nylon-6, or Nylon 6-6. Such materials may be provided as fibers, filaments, threads, yarns, or tows and may be woven, nonwoven, knitted, and/or have any other construction appropriate to form the primary panel 102 and/or seam tape, patch material, accessory material, or component material 104.

In certain embodiments, the material of the second substrate 108 has a melting temperature greater than the material of the first substrate 106. Stated differently, in some embodiments, the melting temperature of the first substrate 106 is less than the melting temperature of the second substrate 108. In some embodiments, the material of the second substrate 108 may have a melting temperature that is greater than the melting temperature of the first substrate by at least about 10° C., about 20° C., about 30° C., about 40° C., about 50° C., about 60° C., about 70° C., about 80° C., about 90° C., and/or about 100° C. In various embodiments, the material of the second substrate 108 may have a melting temperature that is greater than the melting temperature of the first substrate by at least about 100° C., such as about 110° C., about 120° C., about 130° C., about 140° C., about 150° C., about 160° C., about 170° C., about 180° C., about 190° C., and/or about 200° C. In other embodiments, the relative difference between the melting temperature of the second substrate 108 and the melting temperature of the first substrate 106 may be any difference as desired and such that the melting temperature of the second substrate 108 is greater than the melting temperature of the first substrate 106. As one non-limiting example, the first substrate 106 may be ultra-high molecular weight polyethylene, and the second substrate 108 may be polyamide.

Optionally, primary panel 102 and/or the seam tape, patch material, accessory material, or component material 104 may include one or more additional layers 110A-B, 112A-B on the substrates 106, 108, respectively. While two additional layers on opposing sides of the substrates 106, 108 are illustrated, in other embodiments, the primary panel 102 and/or the seam tape, patch material, accessory material, or component material 104 may include a single additional layer and/or a plurality of additional layers, and when a plurality of additional layers are utilized, they may be provided on one or both sides of the substrate as desired. Such additional layers may include, but are not limited to, a metallic layer, an adhesive layer, a coating, a film layer, and/or an inner layer. One or more additional layers may include acrylic, polyolefin, modified polyolefin, polyurethane, vinyl, polyethylene, polypropylene, polyamide, fluoropolymer, polyethylene terephthalate, polystyrene, ethylene vinyl acetate, polyvinylidene chloride, polycarbonate, polyvinyl chloride, polylactic acid, polyvinyl alcohol, ethylene-chlorotrifluoroethylene, polyetherketone, polyetheretherketone, polyetherketoneketone, any other appropriate materials, and/or any combination thereof.

In some non-limiting examples, an additional layer 110 on the first substrate 106 may be different from an additional layer 112 on the second substrate 108. However, in other embodiments, at least one additional layer 110 on the first substrate 106 may be the same as at least one additional layer 112 on the second substrate 108. Optionally, in such embodiments, the additional layers 110, 112 with the same material may be arranged to engage with one another when the seam tape, patch material, accessory material, or component material 104 is provided on the primary panel 102.

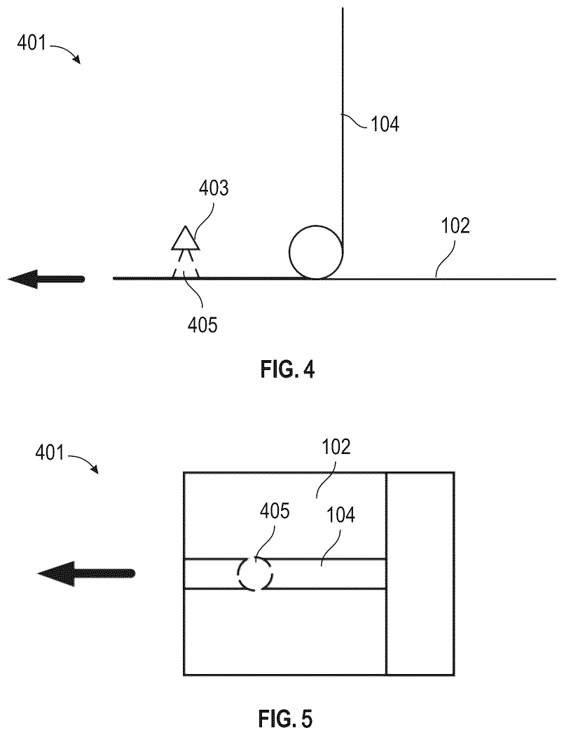

Referring to FIGS. 4-5, a joining system 401 may be utilized to join the seam tape, patch material, accessory material, or component material 104 to one or more primary panels 102. The joining system 401 may include various systems or mechanisms for joining the seam tape, patch material, accessory material, or component material 104 to one or more primary panels 102, such as but not limited to various systems or mechanisms for welding and/or adhesive bonding. As non-limiting examples, the joining system 401 may be configured to join via thermal welding, heat or hot air welding, heated wedge welding, heated roller (or rotary wheel) welding, hot stamped welding, radiofrequency (RF) welding, ultrasonic welding, combinations thereof, or any other appropriate welding method. In the example illustrated in FIGS. 4-5, the joining system 401 includes a heating device 403 for applying energy (e.g., heat) needed to join the seam tape, patch material, accessory material, or component material 104. In various embodiments, by using the second substrate 108 with the higher melting temperature in the seam tape, patch material, accessory material, or component material 104, energy needed to join the components may be applied by the heating device 403 to the seam tape, patch material, accessory material, or component material 104 and not the primary panel 102 (represented by dashed regions 405 in FIGS. 4 and 5), thereby reducing the risk of damaging the primary panel 102.

### FAA Requirements

As mentioned, in certain embodiments, inflatable safety products 100 described herein may meet and/or exceeds the requirements according to TSO-C69c, TSO-C13f, and/or TSO-C70b. Required tests include: seam peel strength, seam shear strength, tensile strength (grab test), tear strength (trapezoid test), tear strength (tongue test), ply adhesion, coat adhesion, temperature resistance, radiant heat resistance, puncture strength, tear propagation, chafe resistance, flammability (vertical burn rate), pressure retention, permeability, porosity (hydrolysis), hydrolysis conditioning, resistance to hydrolysis, fluids exposure, and accelerated aging.

### Seam Adhesion

As a non-limiting example, the fabric or flexible composite material adhered or welded to the fabric or flexible composite material of the inflatable safety product creating a seam region, when separated from the fabric or flexible composite material of the inflatable safety product, at or about a 180° angle, at a separation rate of between 2 and 2.5 inches/minute, at a temperature between 70° F. to 72° F., wherein the average of at least 5 specimens must resist separation with a force of 5 pounds/inch width or greater. The aforementioned resistance to separation, described herein peel strength as referenced in TSOs, such as but not limited to TSO-C69c from the FAA.

As a further non-limiting example, any coatings, films, or layers applied to the substrate of the fabric or flexible composite material, when separated from the substrate or other layers used in the construction of the fabric or flexible composite material, of the inflatable safety product, at or about a 180° angle, at a separation rate of between 2 and 2.5 inches/minute, at a temperature of between 70° F. to 72° F., wherein the average of at least 5 specimens must resist separation with a force of 5 pounds/inch width or greater. The aforementioned resistance to separation, described herein ply adhesion and coating adhesion as referenced in TSOs, such as but not limited to TSO-C69c from the FAA.

### Seam Shear

As a non-limiting example, the fabric or flexible composite material adhered or welded to the fabric or flexible composite material of the inflatable safety product creating a seam region, when used to create a specimen of the seam region and with the fabric or flexible composite material adhered or welded with a ¾ inch maximum overlap, at a separation rate between 11.5 and 12.5 inches/minute, at a temperature of 75° F., wherein the average of at least 3 specimens must resist separation with a force of 175 pounds/inch width or greater when pulled in the shear direction.

As a further non-limiting example, the fabric or flexible composite material adhered or welded to the fabric or flexible composite material of the inflatable safety product creating a seam region, when used to create a specimen of seam region 2 inches in length and with the fabric or flexible composite material adhered or welded at a ¾ inch maximum overlap, at a separation rate of between 11.5 and 12.5 inches/minute, at a temperature of 140° F., wherein the average of at least 3 specimens must resist separation with a force of 40 pounds/inch width or greater when the pulled in the shear direction. The aforementioned resistance to separation, describes shear strength as referenced in TSOs, such as but not limited to TSO-C69c from the FAA.

### Tensile and Tear Strength

As a non-limiting example, the fabric or flexible composite material of the inflatable safety product, when at least 5 specimens prepared as per Federal Test Method Standard-Method 5134 (Tongue Test), are placed between 2 jaws that are 3 inches apart and subjected to a separation rate of between 11.5 and 12.5 inches/minute, at a temperature of 68° F. to 72° F., must a resist separation with a maximum force of an average of at least 13 pounds/inch in warp direction and fill direction (along the manufacturing length and width of the fabric or flexible composite material).

As a non-limiting example, the fabric or flexible composite material of the inflatable safety product, when at least 5 specimens prepared as per Federal Test Method Standard-Method 5136 (Trapezoid Test), are placed between 2 jaws that are 1 inch apart and subjected to a separation rate of between 11.5 and 12.5 inches/minute, at a temperature of 68° F. to 72° F., must a resist separation with a maximum force of an average of at least 13 pounds/inch in warp direction and fill direction (along the manufacturing length and width of the fabric or flexible composite material).

As a further non-limiting example, after aging (exposed to a temperature of 158±4° F. for not less than 168 hours), the fabric or flexible composite of the inflatable safety product, when at least 5 specimens prepared as per Federal Test Method Standard—Method 5134 (Tongue Test), are placed between 2 jaws that are 3 inches apart and subjected to a separation rate of between 11.5 and 12.5 inches/minute, at a temperature of 68° F. to 72° F., must a resist separation with a maximum force of an average of at least 13 pounds/inch in warp direction and fill direction (along the manufacturing length and width of the fabric or flexible composite material).

As a further non-limiting example, after aging, the fabric or flexible composite material of the inflatable safety product, when at least 5 specimens prepared as per Federal Test Method Standard—Method 5136 (Trapezoid Test), are placed between 2 jaws that are 1 inch apart and subjected to a separation rate between 11.5 and 12.5 inches/minute, at a temperature of 68° F. to 72° F., must a resist separation with a maximum force of an average of at least 13 pounds/inch in warp direction and fill direction (along the manufacturing length and width of the fabric or flexible composite material).

As a non-limiting example, the fabric or flexible composite material of the inflatable safety product, when at least 5 specimens prepared as per Federal Test Method Standard—Method 5100 (Grab Test), are placed between 2 jaws that are 3 inches apart and subjected to a separation rate between 11.5 and 12.5 inches/minute, at a temperature of 68° F. to 72° F., must resist separation with a maximum force of an average of at least 190 pounds/inch in warp direction and fill direction (along the manufacturing length and width of the fabric or flexible composite material).

As a further non-limiting example, after aging, the fabric or flexible composite material of the inflatable safety product, when at least 5 specimens prepared as per Federal Test Method Standard—Method 5100 (Grab Test), are placed between 2 jaws that are 3 inches apart and subjected to a separation rate between 11.5 and 12.5 inches/minute, at a temperature of 68° F. to 72° F., must a resist separation with a maximum force of an average of at least 190 pounds/inch in warp direction and fill direction (along the manufacturing length and width of the fabric or flexible composite material).

### Air Holding & Gas Holding

As a non-limiting example, the fabric or flexible composite material, described herein when configured into an inflatable safety product must withstand a pressure of at least 1.5 times the maximum operating pressure for at least 5 minutes of its intended use.

As a further non-limiting example, the fabric or flexible composite material, described herein when configured into an inflatable safety product must withstand a pressure of at least 2 times the maximum operating pressure for at least 1 minute, of its intended use.

As a further non-limiting example, the fabric or flexible composite material, described herein when configured into an inflatable safety inflatable safety product, when inflated to its operating pressure of intended use must not fall below at least 50 percent of its initial pressure in a period less than 12 hours.

As a further non-limiting example, the fabric or flexible composite material, described herein when configured into an inflatable safety product, that is capable of being used as a life raft or flotation device when inflated to its operating pressure of intended use must not fall below the minimum raft mode operating pressure in less than 24 hours.

### Helium Permeability

As a non-limiting example, the fabric or flexible composite material of the inflatable safety product, when at least 3 specimens are prepared and tested as per Federal Test Method Standard—Method 5460 or ASTM Method D1434-82, Procedure V, have a maximum permeability of Helium of 10 liters per square meter in 24 hours at 77° F. or its equivalent in Hydrogen when a pressure is applied to the chamber on the side of the test specimen that separates the test gas (Helium or its equivalent in Hydrogen) from the chamber receiving the permeating gas.

### Temperature Resistance

As a non-limiting example, the fabric or flexible composite material, seam tape, accessory material and or product accessories described herein when exposed to temperatures from −40° F. to 160° F. must remain fully functioning per its intended use as referenced in TSOs, such as but not limited to TSO-C69c from the FAA.

As a further non-limiting example, the fabric or flexible composite material, seam tape, accessory material and or product accessories described herein must remain fully functioning per its intended use after exposure to a storage temperature of 185° F. or greater as referenced in TSOs, such as but not limited to TSO-C69c from the FAA.

As a further non-limiting example, the fabric or flexible composite material, seam tape, accessory material and or product accessories described herein must remain fully functioning per its intended use after being stowed at a temperature −65° F. or less as referenced in TSOs, such as but not limited to TSO-C69c from the FAA.

### Radiant Heat Resistance

As a further non-limiting example, the fabric or flexible composite material described herein when exposed to a radiant heat flux of 1.5 Btu/ft²-sec or greater, wherein a pressure applied to the surface opposite the heat source does not decrease for at least 90 seconds when the surface opposite the heat source is subjected to a higher pressure than the surface subjected to the heat source, wherein the average of the time to pressure decrease of at least 3 specimens of the fabric or flexible composite is at least 180 seconds or greater.

### Fluids Exposure

As a further non-limiting example, the fabric or flexible composite material described herein must be capable of withstanding the detrimental effects of exposure to fuels, oils, hydraulic fluids, and sea water. After being exposed to fuels, oils, hydraulic fluids, and sea water, a seam will not have a decrease in seam strength or coat adhesion of more than 10%.

As a further non-limiting example, the fabric or flexible composite material, described herein must remain capable of withstanding the detrimental effects of exposure to fuels, oils, hydraulic fluids, and sea water with no loss in air holding or gas holding properties. After being exposed to fuels, oils, hydraulic fluids, and sea water, the fabric or flexible composite material, wherein the average of at least 5 specimens in warp direction and fill direction (along the manufacturing length and width of the fabric or flexible composite material) will not have a decrease in coating adhesion, ply adhesion, peel strength, seam shear strength, tensile strength, or tear strength of more than 10% as referenced in TSOs, such as but not limited to TSO-C70b from the FAA.

### Hydrolysis

As a further non-limiting example, the fabric or flexible composite material, described herein must remain capable of withstanding the detrimental effects of hydrolysis exposure to a temperature of 136±4° F. at a relative humidity of 95±4 percent for a period of 50 days with no loss in air holding or gas holding properties. After hydrolysis exposure to a temperature of 136±4° F. at a relative humidity of 95±4 percent for a period of 50 days the fabric or flexible composite material, wherein the average of at least 5 specimens in warp direction and fill direction (along the manufacturing length and width of the fabric or flexible composite material) will not have a decrease in coating adhesion, ply adhesion, peel strength, seam shear strength, tensile strength, or tear strength of more than 20% as referenced in TSOs, such as but not limited to TSO-C69c from the FAA.

### Tear Propagation

As a non-limiting example, the fabric or flexible composite material, described herein when must not allow a tear to propagate beyond the implement that caused an initial puncture or tear as referenced in TSOs, such as but not limited to TSO-C69c from the FAA.

### Accelerated Aging

As a further non-limiting example, the fabric or flexible composite material, described herein must remain capable of withstanding the detrimental effects of accelerated aging at a temperature of 158±4° F. for not less than 168 hours with no loss in air holding or gas holding properties. After accelerated aging at a temperature of 158±4° F. for not less than 168 hours the fabric or flexible composite material, seam tape, accessory material wherein the average of at least 5 specimens in warp direction and fill direction (along the manufacturing length and width of the fabric or flexible composite material) will not have a decrease in coating adhesion, ply adhesion, peel strength, seam shear strength, tensile strength, or tear strength of more than 10% as referenced in TSOs, such as but not limited to TSO-C69c from the FAA.

### Flammability

As a non-limiting example, the fabric or flexible composite material, described herein, wherein the average of at least 3 specimens in warp direction and fill direction (along the manufacturing length and width of the fabric or flexible composite material material) are located 3/4 inches above the top edge of a burner apparatus, for a period of 12 seconds is exposed to a flame with a total length of 1.5 inches and an inner cone length of ⅞ inches, and minimum temperature of 1550° F., shall not burn for more than 15 seconds after the flame is removed, shall not burn more than 8 inches in the vertical direction, wherein any material that drips form the specimen shall not burn to more than 5 seconds, as referenced such as but not limited to the flammability requirements of 14 CFR part 25.853 (a), Appendix F, Part I (a)(1)(ii) as referenced in TSOs, such as but not limited to TSO-C69c from the FAA.

### EXAMPLES

A collection of exemplary embodiments is provided below, including at least some explicitly enumerated as an “Illustration” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A seam tape configured to independently and indirectly couple gas-holding panels to create a gas-holding inflatable product, each gas-holding panel comprising a first substrate, the seam tape comprising: a second substrate having a melt temperature that greater than a melt temperature of the first substrate of the indirectly coupled gas-holding panels to which the seam tape is applied.

Illustration 2. The seam tape of any preceding or subsequent illustration or combination of illustrations, wherein the first substrate and the second substrate are each selected from the group consisting of a polyethylene, ultra-high molecular weight polyethylene, polypropylene, polyester, polyamide, aromatic polyamide, aramid, polyolefin, aromatic polyester, polyarylate, or liquid crystal polymers.

Illustration 3. The seam tape of any preceding or subsequent illustration or combination of illustrations, wherein the first substrate comprises ultra-high molecular weight polyethylene, and wherein the second substrate comprises polyamide.

Illustration 4. The seam tape of any preceding or subsequent illustration or combination of illustrations, wherein the first substrate comprises ultra-high molecular weight polyethylene, and wherein the second substrate comprises polyester.

Illustration 5. The seam tape of any preceding or subsequent illustration or combination of illustrations, wherein the inflatable product comprises one or more of evacuation slides, slide/rafts, ramps, slide/ramps, life rafts, life vests, helicopter floats, and inflatable shelters, emergency flotation devices, ship decoys, and inflatable military targets.

Illustration 6. The seam tape of any preceding or subsequent illustration or combination of illustrations, wherein the melt temperature of the second substrate is at least 10° C. greater than the melt temperature of the first substrate.

Illustration 7. The seam tape of any preceding or subsequent illustration or combination of illustrations, wherein each gas-holding panel further comprises a first coating on the first substrate, and wherein the seam tape comprises a second coating.

Illustration 8. The seam tape of any preceding or subsequent illustration or combination of illustrations, wherein the first coating and the second coating are a same material.

Illustration 9. The seam tape of any preceding or subsequent illustration or combination of illustrations, wherein the first coating and the second coating are selected from the group consisting of polyurethane, vinyl, polyethylene, polypropylene, polyamides, polyethylene terephthalate (PET), polystyrene, ethylene vinyl acetate (EVOH), polyvinylidene chloride (PVDC), polyvinyl alcohol (PVOH), polycarbonate (PC), polyvinyl chloride (PVC), polylactic acid (PLA), a polymer, or any combination thereof.

Illustration 10. The seam tape of any preceding or subsequent illustration or combination of illustrations, wherein the seam tape comprises a tensile strength of at least 190 lbs/in.

Illustration 11. The seam tape of any preceding or subsequent illustration or combination of illustrations, wherein the seam tape comprises a tear strength of at least 13 lbs/in.

Illustration 12. The seam tape of any preceding or subsequent illustration or combination of illustrations, wherein, when exposed to a radiant heat flux of 1.5 Btu/ft²-sec or greater, a pressure applied to a surface opposite a heat source does not decrease for at least 90 seconds when the surface opposite the heat source is subjected to a higher pressure than a surface subjected to the heat source, and an average of a time to pressure decrease of at least 3 specimens of the seam tape is at least 180 seconds or greater.

Illustration 13. The seam tape of any preceding or subsequent illustration or combination of illustrations, wherein the seam tape comprises a seam shear strength of at least 175 lbs/inch at room temperature.

Illustration 14. The seam tape of any preceding or subsequent illustration or combination of illustrations, wherein the seam tape comprises a seam peel strength of at least 5 lbs/inch.

Illustration 14. An inflatable safety product comprising: a gas-holding panel comprising a first substrate comprising a first melt temperature; and a seam tape, patch material, accessory material, or component material joined to the gas-holding panel, wherein the seam tape, patch material, accessory material, or component material comprises a second substrate comprising a second melt temperature, wherein the second melt temperature is greater than the first melt temperature.

Illustration 15. The inflatable safety product of any preceding or subsequent illustration or combination of illustrations, wherein the inflatable safety product comprises evacuation slides, slide/rafts, ramps, slide/ramps, life rafts, life vests, helicopter floats, and inflatable shelters.

Illustration 16. The inflatable safety product of any preceding or subsequent illustration or combination of illustrations, wherein the first substrate and the second substrate are each selected from the group consisting of a polyethylene, ultra-high molecular weight polyethylene, polypropylene, polyester, polyamide, aromatic polyamide, aramid, polyolefin, aromatic polyester, polyarylate, or liquid crystal polymers.

Illustration 17. The inflatable safety product of any preceding or subsequent illustration or combination of illustrations, wherein the first substrate comprises ultra-high molecular weight polyethylene and the second substrate comprises polyamide.

Illustration 18. The inflatable safety product of any preceding or subsequent illustration or combination of illustrations, further comprising a first coating on the first substrate and a second coating on the second substrate, and wherein the first coating and the second coating are a same material.

Illustration 19. A method of adhering a seam tape, patch material, accessory material, or component material to a gas-holding panel, the method comprising: positioning the seam tape, patch material, accessory material, or component material on the gas-holding panel such that the seam tape, patch material, accessory material, or component material receives more heat than the gas-holding panel when adhering the seam tape, patch material, accessory material, or component material to the gas-holding panel, wherein a substrate of the gas-holding panel has a first melt temperature and the substrate of the seam tape, patch material, accessory material, or component material has a second melt temperature greater than the first melt temperature.

Illustration 20. The method of any preceding or subsequent illustration or combination of illustrations, further comprising applying heat to the seam tape, patch material, accessory material, or component material, wherein applying heat comprises heating to a temperature less than the second melt temperature, and wherein the substrate of the gas-holding panel comprises ultra-high molecular weight polyethylene and the substrate of the seam tape, patch material, accessory material, or component material comprises polyamide.

Illustration 21. A seam tape configured to independently and indirectly couple panels to create an inflatable product, each panel comprising a first substrate, the seam tape comprising: a second substrate having a melt temperature that greater than a melt temperature of the first substrate of the indirectly coupled panels to which the seam tape is applied.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. In the figures and the description, like numerals are intended to represent like elements. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12”. As used herein, the meaning of “a,” “an,” and “the” includes singular and plural references unless the context clearly dictates otherwise.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g., 1 to 6.1, and ending with a maximum value of 10 or less, e.g., 5.5 to 10.

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed is:

1. A seam tape configured to independently and indirectly couple gas-holding panels to create a gas-holding inflatable product, each gas-holding panel comprising a first substrate, the seam tape comprising:
a second substrate having a melt temperature that is greater than a melt temperature of the first substrate of the indirectly coupled gas-holding panels to which the seam tape is applied.

2. The seam tape of claim 1, wherein the first substrate and the second substrate are each selected from the group consisting of a polyethylene, ultra-high molecular weight polyethylene, polypropylene, polyester, polyamide, aromatic polyamide, aramid, polyolefin, aromatic polyester, polyarylate, or liquid crystal polymers.

3. The seam tape of claim 1, wherein the first substrate comprises ultra-high molecular weight polyethylene, and wherein the second substrate comprises polyamide or polyester.

4. The seam tape of claim 1, wherein the inflatable product comprises evacuation slides, slide/rafts, ramps, slide/ramps, life rafts, life vests, helicopter floats, and inflatable shelters, emergency flotation devices, ship decoys, and inflatable military targets.

5. The seam tape of claim 1, wherein the melt temperature of the second substrate is at least 10° C. greater than the melt temperature of the first substrate.

6. The seam tape of claim 1, wherein each gas-holding panel further comprises a first coating on the first substrate, and wherein the seam tape comprises a second coating.

7. The seam tape of claim 6, wherein the first coating and the second coating are a same material.

8. The seam tape of claim 6, wherein the first coating and the second coating are selected from the group consisting of polyurethane, vinyl, polyethylene, polypropylene, polyamides, polyethylene terephthalate (PET), polystyrene, ethylene vinyl acetate (EVOH), polyvinylidene chloride (PVDC), polyvinyl alcohol (PVOH), polycarbonate (PC), polyvinyl chloride (PVC), polylactic acid (PLA), a polymer, or any combination thereof.

9. The seam tape of claim 1, wherein the seam tape comprises a tensile strength of at least 190 lbs/in and a tear strength of at least 13 lbs/in.

10. The seam tape of claim 1, wherein, when exposed to a radiant heat flux of 1.5 Btu/ft²-sec or greater, a pressure applied to a surface opposite a heat source does not decrease for at least 90 seconds when the surface opposite the heat source is subjected to a higher pressure than a surface subjected to the heat source, and an average of a time to pressure decrease of at least 3 specimens of the seam tape is at least 180 seconds or greater.

11. The seam tape of claim 1, wherein the seam tape comprises a seam shear strength of at least 175 lbs/inch at room temperature.

12. The seam tape of claim 1, wherein the seam tape comprises a seam peel strength of at least 5 lbs/inch.

13. An inflatable safety product comprising:
a panel comprising a first substrate comprising a first melt temperature; and
a seam tape, patch material, accessory material, or component material joined to the gas-holding panel, wherein the seam tape, patch material, accessory material, or component material comprises a second substrate comprising a second melt temperature, wherein the second melt temperature is greater than the first melt temperature.

14. The inflatable safety product of claim 13, wherein the panel comprises a gas-holding panel or a non-gas-holding panel.

15. The inflatable safety product of claim 13, wherein the inflatable safety product comprises evacuation slides, slide/rafts, ramps, slide/ramps, life rafts, life vests, helicopter floats, and inflatable shelters.

16. The inflatable safety product of claim 13, wherein the first substrate and the second substrate are each selected from the group consisting of a polyethylene, ultra-high molecular weight polyethylene, polypropylene, polyester, polyamide, aromatic polyamide, aramid, polyolefin, aromatic polyester, polyarylate, or liquid crystal polymers.

17. The inflatable safety product of claim 13, wherein the first substrate comprises ultra-high molecular weight polyethylene and the second substrate comprises polyamide or polyester.

18. The inflatable safety product of claim 13, further comprising a first coating on the first substrate and a second coating on the second substrate, and wherein the first coating and the second coating are a same material.

19. A method of adhering a seam tape, patch material, accessory material, or component material to a gas-holding panel or a non-gas-holding panel, the method comprising:
positioning the seam tape, patch material, accessory material, or component material on the gas-holding panel or non-gas-holding panel such that the seam tape, patch material, accessory material, or component material receives more heat than the gas-holding panel or non-gas-holding panel when adhering the seam tape, patch material, accessory material, or component material to the gas-holding panel or non-gas-holding panel,
wherein a substrate of the gas-holding panel or non-gas-holding panel has a first melt temperature and the substrate of the seam tape, patch material, accessory material, or component material has a second melt temperature greater than the first melt temperature.

20. The method of claim 19, further comprising applying heat to the seam tape, patch material, accessory material, or component material, wherein applying heat comprises heating to a temperature less than the second melt temperature, and wherein the substrate of the gas-holding panel or non-gas-holding panel comprises ultra-high molecular weight polyethylene and the substrate of the seam tape, patch material, accessory material, or component material comprises polyamide.
